(19) United States
(12) Patent Application Publication
(10) Pub. No.: US 2002/0069082 A1
(43) Pub. Date: Jun. 6, 2002

(54) Electronic commerce system and operating method thereof

(75) Inventors: Kwang Soo Choe, Seoul (KR); Young Min You, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 09/998,412

(22) Filed: Dec. 3, 2001

(30) Foreign Application Priority Data
Dec. 2, 2000 (KR) 2000-72638
Jan. 31, 2001 (KR) 2001-4466
Jan. 31, 2001 (KR) 2001-4467

(51) Int. Cl. G06F 17/60

(52) U.S. Cl. 705/1

(57) ABSTRACT

Disclosed is an electronic commerce system and method, which is characterized by displaying only available products for the corresponding dealing company on a web page. E-commerce transactions are performed by considering the locations of the respective dealing companies and a distribution network thereof, performing a fast and smooth dealing for various expenses on e-commerce processing, and using a process for easily placing and receiving an order between the dealing companies. Therefore, the system and method automatically determines whether errors have occurred in the orders placed by the respective dealing companies, and automatically cures the generated errors in connection with other components, thereby preventing and curing the errors generated from the transaction processes previously.

### BACKGROUND OF THE INVENTION

1. Field of the Invention

The present invention relates to a system and method for electronic commerce, and more particularly to a system and method for on-line product trade using electronic commerce.

2. Background of the Related Art

The recent rapid progress in information telecommunication between computers has improved business efficiency and has changed the way of life. For instance, electronic commerce (e-commerce), which provides for on-line shopping over a computer network, has become increasingly popular.

The popularity of such on-line e-commerce, however, has been somewhat subdued, especially for individual customers, due to the failure to provide direct dealing between a purchaser and a provider. On the contrary, usage of Business to Business (B-to-B) transactions has tended to increase by making a dealing through a reciprocal contract between a sales distributor and a purchaser.

The current B-to-B systems and methods have various problems, such as, lack of convenient and fast contracting, various expenses, transactions considering the location and distribution network of a business company, credit management for the respective dealing companies, and the like.

For example, when issuing an instruction for placing and receiving an order between the product purchaser and the sales distributor, many factors should be considered. These factors include the amount of surplus stock, the storage capacity of a warehouse for warehousing and delivery, schedule for the warehousing and delivery, the availability of manufacturing the corresponding product due on a corresponding shipping date, and so on. Thus, personnel of the sales distributor and the buyer companies should carry out additional on-line services for reconciling their opinions before placing an order. Therefore, the related art e-commerce method for placing and receiving an order is not convenient.

Additionally, a product purchasing company in a typical B-to-B transaction has a burden in asking for delivery of a product after having paid the expense for buying the corresponding product. This requires an additional preceding off-line agreement between the reciprocal companies. A letter of credit through a banking corporation enables the trade to be quickly processed. However, a new letter of credit must be opened for every transaction. Moreover, for each letter of credit, a conference between the reciprocal companies and the verification of the corresponding banking corporation are required. Thus, the method using the letter of credit fails to be effective. Hence, the related art e-commerce system cannot easily process the various transaction expenses.

Next, considering the competition between at least two retailers, a wholesaler generally carries out the sale of different goods (or goods having different performances). Yet, a sale though e-commerce never considers such factors, thereby bringing about the chaos in the sub-distribution network.

Moreover, although credibility between the respective companies is required for carrying out the e-commerce between the respective companies, fair evaluation for the dealing company fails to be provided due to the database attained by carrying out credit measurement of the corresponding dealing company through an off-line verification. Hence, the related art e-commerce system cannot perform fair evaluation for the corresponding dealing company so as to manage the credits of the respective dealing companies.

### SUMMARY OF THE INVENTION

Accordingly, it is an object of the present invention to provide an electronic commerce system and operating method thereof that substantially obviates one or more problems due to limitations and disadvantages of the related art.

It is a further object of the present invention to provide a system and method for performing e-commerce that considers the locations of the respective dealing companies and a distribution network thereof.

It is another object of the present invention to provide an e-commerce system and method that process various e-commerce expenses quickly and efficiently.

It is a further object of the present invention to provide a convenient and efficient e-commerce process for placing and receiving orders between the dealing companies.

To achieve at least these objects in whole or in parts, there is provided an e-commerce system including a database server configured to store information relating to respective dealing companies, information of orders placed by the respective dealing companies, information about respective sales products, information about respective order errors, information about order-available products for the respective dealing companies, and the like, a web server coupled to the database server and configured to operate a web site to receive order sheets on-line from the respective dealing companies for an on-line sale of the respective products and to select the order-available products for the respective dealing companies so as to display only items of the selected products on an interface screen, an information acquisition server, which is being connected on-line, configured to continuously acquire information about the respective dealing companies and register the acquired information to the database server; and an order control server, configured to gather information about ordered items inputted through the web server and the respective order errors stored in the database server so as to determine whether the error of the corresponding order is correct, and to carry out a selective order control in accordance with the determination.

To further achieve at least the above objects in whole or in parts, there is provided an e-commerce system having a database server configured to store information relating to respective dealing companies, information about respective sales products, information about order-available products for the respective dealing companies, and the like, and a web server, coupled to the database server, operating a web site for an on-line sale of the respective products, and selecting the order-available products for the respective dealing companies so as to display items of the selected products only on an interface screen.

To further achieve at least the above objects in whole or in parts, there is provided an e-commerce system having a database server configured to store information about respective dealing companies and credit information of the respective dealing companies, credit limit amount information of the respective dealing companies wherein the credit limit amount information is established by considering the credit information, and information of respective sales products, and information of an order control for each situation, and a web server linked to the database server and operating a web site to receive an on-line order for an on-line sale of each of the products within a credit limit amount of each of the dealing companies.

To further achieve at least the above objects in whole or in parts, there is provided an e-commerce system having a database server configured to store information concerning respective dealing companies and credit information of the respective dealing companies, order restriction information of respective statuses including amounts in stock by the respective models of sales products, sale or sale-suspension of the respective models of the sales products, out-of-production or production of the respective models of the sales products, and the like, and a web server coupled to the database server, and configured to operate a web site to receive an on-line order for a sale of each of the products, acquiring recent information about the respective products and dealing companies continuously so as to register the acquired information to the database server, and carrying out, when an order for a product purchase is generated from each of the dealing companies, an order control for the order-generating dealing company.

To further achieve at least the above objects in whole or in parts, there is provided an e-commerce system having a database server for storing information relating to respective dealing companies, information about respective sales products, information about respective order errors, item information of respective confirmed orders, and the like, a web server for operating a web site to receive an on-line order for the sale of the respective products from the respective dealing companies, an error processing server for searching an error through order information of the respective products received through the web site operated by the web server, and an order confirmation server for carrying out a confirmation of the order which has no error or of which error has been cured.

To further achieve at least the above objects in whole or in parts, there is provided a method of operating an e-commerce system, including a first step of checking each order restriction information for a corresponding dealing company from a database server when an on-line connection is made from respective dealing companies; a second step of making a classification into order-available products and order-unavailable products on the basis of the checked order restriction information; a third step of displaying a list of the order-available products in the classified products and information about the corresponding products on a web page; a fourth step of, when receiving a trade order for a specific product in the respective displayed order-available products, yielding an expense of the corresponding ordered product on the basis of the received order items so as to examine whether the yielded expense exceeds a credit limit amount given randomly to the corresponding dealing company, as well as checking (i) whether the received purchase order items belong to order restriction items of respective situations set up previously in the database server (ii) and whether the received purchase order items belong to order error items set up previously in the database; and a fifth step of carrying out an order confirmation on the corresponding purchase order items if there is no abnormality in the order items through the respective procedures in the fourth step.

To further achieve at least the above objects in whole or in parts, there is provided a method of operating an e-commerce system, including a first step of checking each order restriction information for a corresponding dealing company from a database server when an on-line connection is made from respective dealing companies; a second step of making a classification into order-available products and order-unavailable products on the basis of the checked order restriction information; and a third step of displaying a list of the order-available products in the classified products and information about the corresponding products on a web page.

To further achieve at least the above objects in whole or in parts, there is provided a method of operating an e-commerce system, including a first step of, when receiving a trade order for a specific product in respective products sold through a web site for an e-commerce from respective dealing companies, yielding a sales expense of the corresponding ordered product on the basis of received order items; a second step of determining whether the yielded expense exceeds a credit limit amount given randomly to the corresponding dealing company; a third step of, if the yielded expense exceeds the given credit limit amount, reporting that the yielded expense exceeds the credit limit amount so as to request a readjustment of the order, or, if the yielded expense fails to exceed the given credit limit amount, deducting the expense from the corresponding credit limit amount and then readjusting information of the balanced credit limit amount into a remaining credit amount of the corresponding dealing company.

To further achieve at least the above objects in whole or in parts, there is provided a method of operating an e-commerce system, including a first step of receiving orders for product purchases from respective dealing companies continuously through a specific web site on-line; a second step of, when receiving a trade order for a specific product in respective products proposed through a web page operated by the web site, comparing to check the received purchase order items and previously set-up order restriction items for respective situations; and a third step of carrying out a restriction on the corresponding order if the received purchase order items belong to at least one of the order restriction items of the respective situations through the second step or carrying out an order confirmation allowing the order on the corresponding order if the received purchase order items fail to belong to the order restriction items of the respective situations through the second step.

To further achieve at least the above objects in whole or in parts, there is provided a method of operating an e-commerce system, including a first step of receiving orders for product purchases from respective dealing companies continuously through a specific web site on-line; a second step of, when receiving a trade order for a specific product in respective products proposed through a web page operated by the web site, searching whether the received purchase order items belong to order error items set up previously in the database on the basis of the received order items; a third step of, if the received purchase order items belong to the order error items set up previously in the database server, temporarily suspending the next proceeding operations for the order belonging to the error items and reporting the error items as well as checking continuously whether the error is settled; and a fourth step of confirming an order sheet for the normal order items or error-settled order items.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a structural diagram for an e-commerce system according to a preferred embodiment of the present invention;

FIG. 2 is a flowchart illustrating a process for registering a credit limit amount according to the preferred embodiment;

FIG. 3 is a flowchart illustrating a process for registering a product availability for ordering by each dealing company according to the preferred embodiment;

FIG. 4 is a flowchart illustrating a method of an e-commerce system according to a preferred embodiment of the present invention;

FIG. 5 is a flowchart illustrating an operation for a divisional shipment of the process in FIG. 4;

FIG. 6 is a flowchart illustrating an operation for a shipment of the process in FIG. 4;

FIG. 7 is a flowchart illustrating an operational process when requested for changing a credit limit during the process in FIG. 4;

FIG. 8 is a diagram illustrating an e-commerce system according to a second embodiment of the present invention;

FIG. 9 is a diagram illustrating an operational process in the second embodiment of the present invention;

FIG. 10 is a diagram illustrating an e-commerce system according to a third embodiment of the present invention;

FIG. 11 to FIG. 14 illustrate operational processes according to the third embodiment of the present invention;

FIG. 15 is a diagram illustrating an e-commerce system according to a fourth embodiment of the present invention; and

FIG. 16 and FIG. 17 illustrate operational processes according to the fourth embodiment of the present invention.

### DETAILED DESCRIPTION OF THE INVENTION

Reference will now be made in detail to the preferred embodiments of the present invention, examples of which are illustrated in the accompanying drawings.

The preferred embodiment of the present invention is characterized in that e-commerce is preferably performed by considering the locations of the respective dealing companies and corresponding distribution networks, providing for fast and smooth handling of various expenses related to e-commerce processing, and conveniently a process for placing and receiving orders between the dealing companies is carried out conveniently.

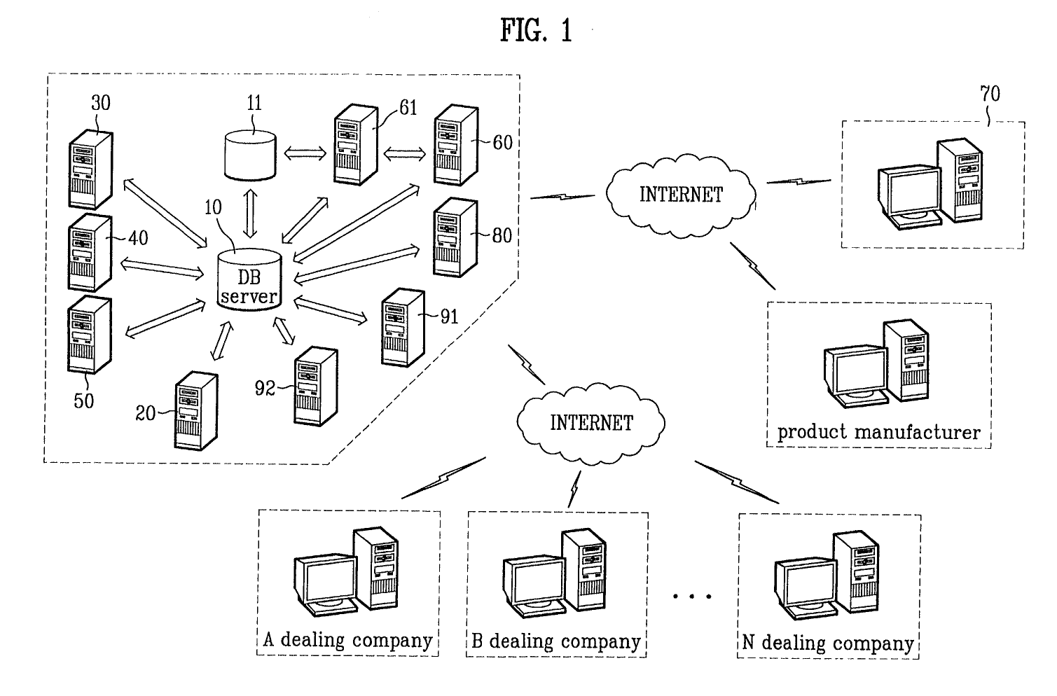

FIG. 1 illustrates a structural diagram for an e-commerce system according to a preferred embodiment of the present invention.

Referring to FIG. 1, an e-commerce system according to the present invention preferably includes a database server 10 for storing various kinds of information, a web server 20 for operating an on-line web site for e-commerce, and an information acquisition server 30 for acquiring various kinds of information. It preferably further includes an order control set-up server 40 for establishing the items of an account for an order limit of each dealing company using the acquired information, an order control server 50 for controlling each purchasing order, and an order confirmation server 60 for carrying out a confirmation of a product order received on-line from the respective dealing companies.

The database server 10 is preferably configured to store information relating to the respective dealing companies, information regarding orders placed by the respective dealing companies, and information about the respective sales products. The database server 10 may further store information regarding the items of an order for the order control, as well as the respective ordering errors. Additionally, credit information of the respective dealing companies and information regarding credit limit amounts of the respective dealing companies, which are set up in accordance with the credit information, are preferably stored in the database server 10. The database server 10 may also store stock information of each model of the sales products, information concerning whether to stop selling the respective models of the sales products, information about ceased models of the respective sales products, and accounting information of the items for each confirmed order. It should be understood that other information items could be stored in the database, and that the above description is not intended to limit that which can be stored.

The web server 20 is coupled to the database server 10, and preferably operates a web site to receive on-line orders from the respective dealing companies for an on-line sale of the respective products. The web server 20 also controls which of the product items, which are selected to be available for order from the respective dealing companies are to be displayed on an interface screen (web page).

The information acquisition server 30 preferably acquires information about the respective dealing companies and registers the acquired information in the database server 10. The data acquisition is preferably performed on a continuous basis. The information acquisition server 30 is preferably coupled to the database server 10.

The order control server 50 preferably gathers information about the items ordered through the web server 20. It also gathers information about the respective order errors and the order control items stored in the database server 10, so as to determine whether the errors are accurate. The order control server 50 then selectively carries out the order control in accordance with this determination.

The order confirmation server 60 carries out a scheduled order processing so that a product shipment amounting to at least the partial quantity of the total order quantity of the order-confirmed products is accomplished every set-up date. The order confirmation server 60 further comprises a divisional order processing server 61 for registering the completed items of the scheduled orders in the temporary order information storage unit 11. The allocation in the temporary order storage unit 11 is preferably performed randomly.

Thus, the temporary order storage unit 11 proposes a predetermined information storing area randomly allocated to the database server 10. The temporary order storage unit 11, which is not limited to such a proposal, may be constructed with an additional server so as to temporarily register the order that is processed divisionally by the respective schedules.

Moreover, the e-commerce system according to the preferred embodiment further includes a shipment confirmation server 80 linked to each warehouse network 70 so as to confirm the shipment of the corresponding order quantity of the respective orders. The shipment confirmation server 80 is preferably configured to be controlled in connection with the web server 20 and database server 10, respectively, as well as the warehouse network 70.

The warehouse network 70 is preferably a network built for every corresponding warehouse to manage the respective off-line warehouses in which the in stock products are stored.

Next, the e-commerce system preferably further includes a credit information management server 91 for managing the credit information of the respective dealing companies, and a grade allotment server 92 for establishing credit limit amounts for each of the respective dealing companies.

The credit information management server 91 preferably produces a purchase expense of a specific dealing company for which an order is received through the web site. It then determines whether to approve the corresponding order by comparing the order expense and the credit limit amount given to the corresponding dealing company. Finally, it performs item management when a variation of the credit limit amount of each of the dealing companies occurs.

The grade allotment server 92 allots a grade as an allotting reference of the credit limit amount of each of the dealing companies on the basis of the information acquired from the information acquisition server 30 relating to the dealing companies.

An operating method of the above-constructed e-commerce system according to a preferred embodiment of the present invention is explained in the following description.

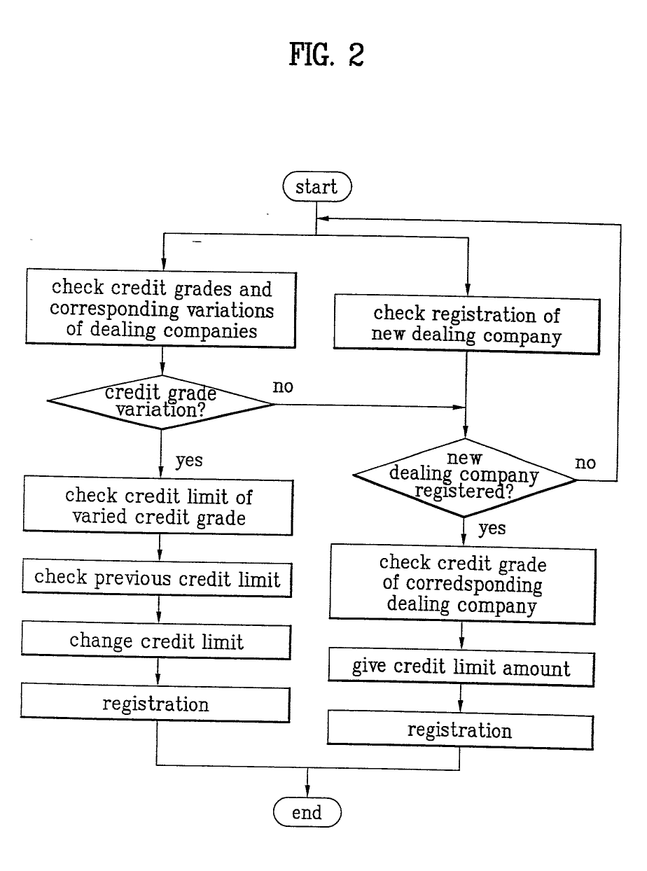

FIG. 2 illustrates a process for registering a credit limit amount. The information acquisition server 30 preferably keeps acquiring and verifying the information about the credit grade variations of the respective dealing companies and the information about the distribution channel and credit grade of a company asking for a new service subscription. This information is thus registered in the database server 10.

The state linked to a web site evaluating the credit grades of the respective companies on-line allows for the acquisition of the credit information about the respective dealing companies. Alternatively, the information acquisition can be accomplished by receiving the credit information, which is obtained off-line, about the respective dealing companies.

When the credit grade variation of each of the respective dealing companies is acquired, the credit limit amount can be readjusted, by increasing or decreasing in accordance with the corresponding credit grade. The adjusted value is then stored in the corresponding database server 10.

While the above process is carried out, the grade allotment server 92 preferably confirms the credit grades of the respective dealing companies on the basis of the information regarding the respective dealing companies. This information is preferably acquired from the information acquisition server 30. The grade allotment server 92 then carries out the allotment of the credit limit amounts in accordance with the credit grades so as to continuously register the allotment in the database server 10.

The allotting process of the credit limit amounts of the respective dealing companies is described in more detail as follows. First, membership registration is received from the dealing company.

Then, the confirmation about the credit grade of the corresponding dealing company is accomplished by referring to the information regarding the corresponding subscribing dealing company. This information is preferably acquired when the corresponding dealing company carries out the membership registration through the on-line web site. Additionally, the confirmation process also uses information acquired by the information acquisition server. This information includes, for example, grade information attained by having the corresponding dealing company evaluated by a banking or credit corporation, general credit information regarding the dealing company evaluated by different companies, self-evaluated information by taking the previous transaction items as references, and so forth. The credit limit amount previously established in accordance with the confirmed credit grade is thus given thereto.

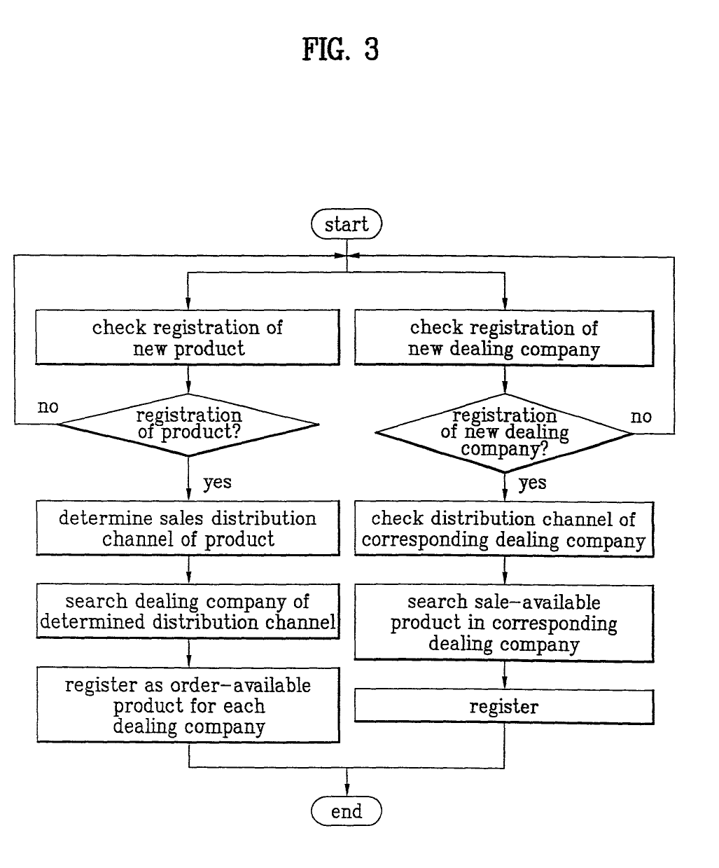

Alternatively, referring to FIG. 3, the order control set-up server 40 selectively carries out the order limit establishment for the confirmed products of the respective dealing companies. This is done by verifying the information about the distribution channel variations of the respective dealing companies previously registered in the database server 10 and new product information designated to carry out a sale through the corresponding web site, a list of products available for orders of the respective dealing companies is then updated so as to register the updated list to the database server 10.

The establishment for the order restriction products for each of the dealing companies is set up by taking the distribution channels or scales of the respective dealing companies as references. This is done by determining the sales distribution channel for the corresponding product when the registration of a specific product is confirmed and by being established such that the sale is limited to only the corresponding dealing company by verifying the respective dealing companies belonging to the determined distribution channel.

Specifically, information such as a location of the corresponding dealing company and a distribution channel, for example, are requested as part of the information being asked to the respective dealing companies for the service registration to the corresponding web site. This information is used for the order restriction of the respective dealing companies. The registration as the order-available or order-unavailable product for the respective sales products and new products is preferably carried out based on the acquired information.

If the service registration of a new dealing company is made during the above step, the distribution channel of the corresponding dealing company is verified. Then, the order restriction information of the corresponding dealing company is registered by searching the sale-available product in this distribution channel only.

The order restriction of products of each distribution channel is selectively established so that the product items for sale through an upper distribution channel are distinguished from those through a lower distribution channel.

For instance, if the same products are sold at the same price to a first dealing company (such as a discount house, etc.) operating a wholesale business, and also to a second dealing company (such as an agency, etc.) operating a retail shop, the entire market order may collapse. Thus, the products sold to the wholesaler and the retailer are always discriminated so as to prevent the above-mentioned problems from occurring.

The order restriction of the products through the respective distribution channels, however, does not have to be carried out in the above manner. Instead, considering the competition between the respective dealing companies (such as relation between agencies located in the specific area), it is preferable that the same products are not sold.

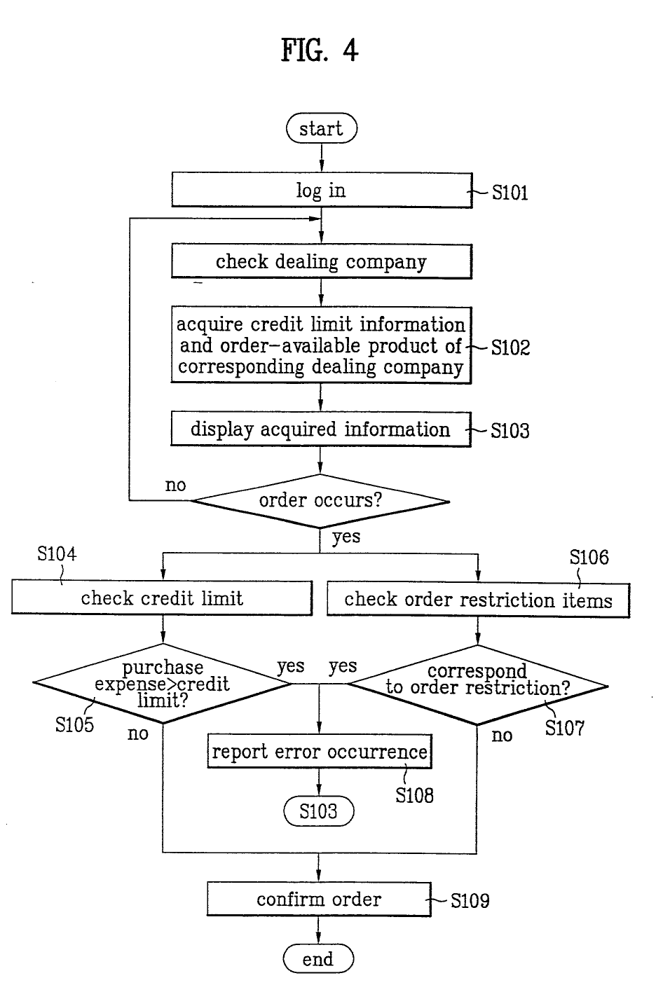

FIG. 4 illustrates a method of performing an e-commerce transaction according to the preferred embodiment. Referring to FIG. 4, when a specific dealing company is linked to a web site operated by the e-commerce system, the acquisition and registration of various kinds of information are continuously carried out by the above component parts. Additionally, a prescribed transaction is commenced when the web server 20 asks the linked dealing company to log-in (S101). The log-in procedure is used to verify the corresponding dealing company.

The web server 20 next acquires information about order restriction products and order-available products for the corresponding dealing company. This information, which is preferably registered in the database server 10, is retrieved on the basis of the verified information. The web server 20 also selects the information relating to a list of the acquired order-available products and the corresponding products. The web server 20 then displays the selected list on the corresponding web page so as to prevent a user from attempting to purchase or otherwise access items that are not available. Thus, only displayed items are available.

The order restriction products preferably further include products in short stock, no-more-sale products, ceased products, and the like, as well as order-restricted products associated with the distribution channel of the corresponding dealing company. By invoicing these items on the order-restriction category, errors due to unnecessary orders are prevented.

The web server 20 also acquires information about the credit limit of the corresponding dealing company registered in the database server 10 (S102). This is done to the control display of the acquired information and the respective product information on the web page (S103).

Thereafter, when a purchase order for at least one of the respective products displayed on the web page from a dealing company is carried out, the credit information management server 91 and order control server 50 determine whether errors have occurred in the corresponding order on the basis of the purchase order.

To determine whether an error has occurred by the credit information management server, the credit limit of the company placing the corresponding order is verified in conjunction with the purchase expense of the ordered products (S104). The credit limit amount and the purchase expense are thus compared to each other (S105). If the product purchase order exceeds the credit limit given to the corresponding dealing company, it is determined that an error has occurred in the corresponding order.

The respective order restriction items registered in the database server 10 are next verified (S106). The order control server 50 then checks for errors by determining whether the products ordered by the corresponding dealing company belong to the order restriction products (S107).

In the above description, the order restriction items may include order restriction items of each of the product models, the order restriction items of each of the dealing companies, input errors according to the respective order items, and the like.

The order restriction items of the product models include the items for which the sale of the corresponding model has ceased, which are no longer made, or for which a quantity of the purchase order fails to meet the minimum quantity of the order-available quantity (for instance, a product of which cost is less than a delivery cost is asked for sale, etc.).

The order restriction items of the dealing companies preferably include items for which the corresponding dealing company has gone out of business due to dishonor, bankruptcy, and the like, for which the corresponding dealing company has committed illegal acts (such as fraud, illegal product distribution, etc.), or for which the corresponding dealing company is in arrears or has ordered an excessive quantity compared to the credit of the corresponding company. Order restriction items of the dealing company may also include items for which the corresponding company has a history of excessive returning-goods/retrocession and redemption, has a bad reputation in the same business circle, or has a reduced ability to make payments.

Such processes are executed to prevent the problems and errors from later occurring due to information that has been omitted or changed between initiation and selection of the restricted items of the respective dealing companies.

That is, because information could be omitted due to the time difference generated in the process of sharing (or updating) the information, the most preferable method includes continuously verifying the order restriction items of the respective products and dealing companies. The method further includes registering the verified order restriction items in the database server 10 on a real-time basis, and informing the verified order restriction items during the log-in procedure from a specific dealing company. Yet, the most preferable method is not limited to this.

The items for the order errors generated from the above processes are transmitted to the corresponding dealing company through various on-line communication systems, such as e-mail (S108). The transmission preferably instructs the recipient to cure the corresponding error. After the error is cured, the confirmation of the corresponding order is executed through the order confirmation server 60 (S109).

In some instances, it may not be possible to confirm the received order upon receipt. For instance, the ordered product may not exist on the sales list, a price of the ordered product may differ from the previously set-up minimum price, or a quantity of the available product in stock may be less than that which was ordered, for example.

Thus, when a quantity of the available products in stock is less than the quantity ordered, it is preferable that a divisional shipment be carried out with the consent of the dealing company that placed the corresponding order.

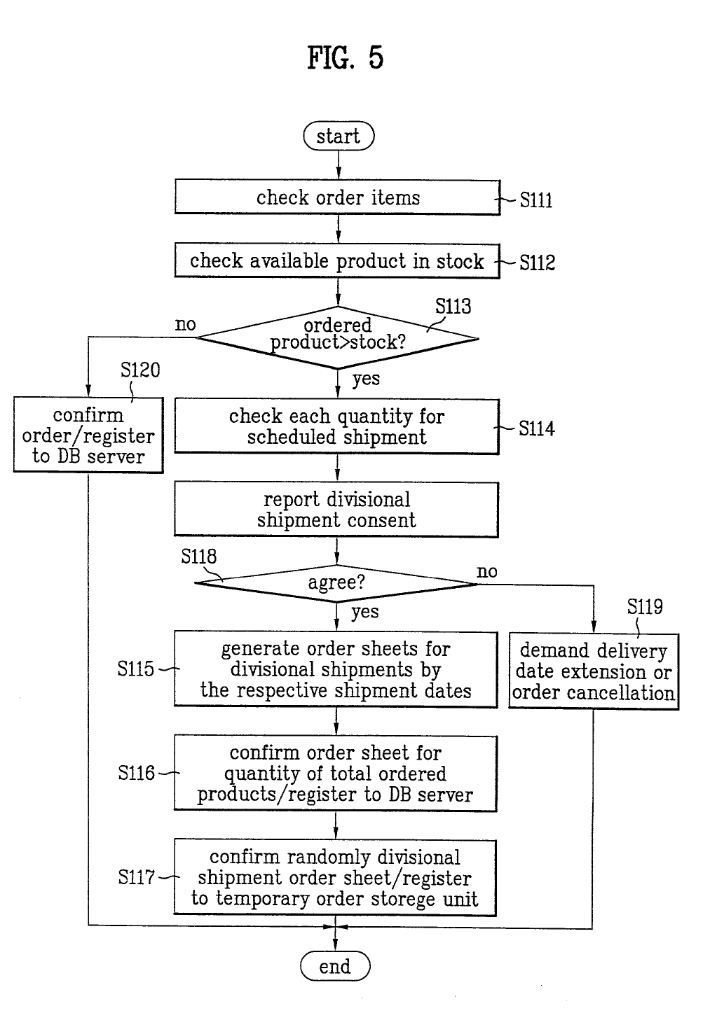

FIG. 5 illustrates an operation for a divisional shipment of the process shown in FIG. 4.

Referring to FIG. 5, a method for divisional shipment first checks order items in a process of carrying out a confirmation on an order (S111). Next, the amount of available products in stock, for example, items stored in a warehouse, are checked (S112). The amount of ordered items are then compared to the inventory in stock (S113). It is thus determined if the ordered quantity exceeds that in stock.

If the ordered quantity exceeds the stock, a quantity of shipment-available products is determined according to each schedule of the corresponding products (S114). It is thus determined whether a portion of the shipment is possible. If a portion of the order can be shipped, a divisional shipment amounting to a predetermined quantity for each shipment-available date is possible. The divisional shipment is then reported to the dealing company, and consent to send the divisional shipment is requested (S118). If consent is given, the process continues.

Thus, order sheets for the divisional shipments for each available shipment dates, respectively, a divisional order processing server 61 preferably acquires information regarding the ordered items from a network built with the web server 20, the warehouse network 70 for managing the warehouse, and a company (or a department) manufacturing the corresponding product. Information about the available products in stock and stored in the respective warehouses, and information about the quantity of the products for each shipment-available date is also acquired.

When the divisional shipment order sheet is generated, an order sheet for the total quantity of initially ordered products is confirmed as a single order sheet (S116). Additionally, the order sheets for the divisional shipments are confirmed randomly as divisional shipment order sheets (S117).

The single order sheet is registered to the database server 10, and the randomly-confirmed divisional shipment order sheets are registered to the temporary order storage unit 11.

The temporary order storage unit 11 is preferably a prescribed information storage area randomly allocated to the database server 10. The temporary order storage unit 11, however, is not limited to the database server 10, but may be replaced by a server configured for the registration of the order handled as the divisional order for each schedule.

Thus, for any given dealing company, a product quantity for the divisional shipment is confirmed as one order regardless of the item or quantity of the product. The respective detailed shipment plan is classified to manage as temporary information so as to make the shipment by the respective temporary unit orders. Thus, information management is simplified by carrying out information management on one entire confirmation order.

As the original shipment order sheet is registered in the database server 10, information of shipment completion for each shipment date verified by the shipment confirmation server 80 becomes the information for the respective divisional shipment order sheets registered in the temporary order storage unit 11. This prevents the chaos of a substantial shipment process.

After the completion of each divisional shipment for each shipment date, the corresponding divisional shipment order sheet is deleted from the temporary order storage unit 11. The information of the corresponding divisional shipment order sheet is also transmitted to the database server 10 so as to be registered to the information storage area of the single order sheet in connection with the corresponding divisional shipment order sheet.

After the completion of the entire divisional shipment, the shipment completion for the single order sheet is registered. The shipment progress is thus acknowledged.

If, in step S118, the consent of the corresponding dealing company is not given for the divisional shipment, it is preferably confirmed again whether the delivery of the corresponding quantity of the product is possible within the due data of the order for the company (or department) substantially manufacturing the corresponding product.

If it is confirmed that the shipment is possible within the due date through the above process, the confirmation for the corresponding order is carried out. Otherwise, an extension of the due date of delivery is sought from the corresponding dealing company through a re-conference, or the order is cancelled (S119).

If the stock on-hand exceeds the ordered quantity in step S113, the confirmation of the corresponding order is carried out normally, without the consent of the dealing company for the divisional shipment (S120).

Meanwhile, when the confirmation of the order through the above-described steps is completed, the items associated with the confirmation are registered to the database server 10, and linked to the warehouse network 70. Shipment of the ordered items is thus performed in accordance with the corresponding order sheet.

A shipment method for this is similar to that of the previously described divisional shipment. Namely, if the shipment completion for the respective shipment order sheets is confirmed through the shipment confirmation server 80 linked to the warehouse network 70, this confirmation information is acquired so as to be registered to the database server 10.

In order to carry out shipment operations more precisely in the process of carrying out the above shipment, it is preferable that the errors be re-verified for the corresponding shipment product.

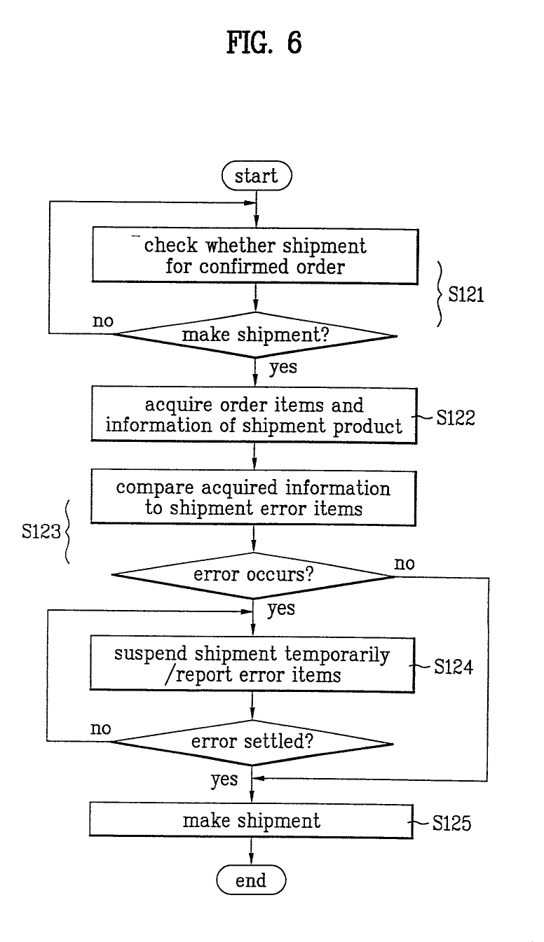

Thus, referring to FIG. 6, a shipment of the product for the confirmed order is first carried out (S121). Next, various information is gathered (S122). This information includes information regarding the corresponding order sheet acquired from the database server 10, and information regarding the product for shipment which is acquired by the shipment confirmation server 80 through the warehouse network 70. Next, it is determined whether at least a portion of the gathered information corresponds to the error item information previously established in the database server 10 (S123).

The error item information may include, for example, whether an item of the corresponding product is different the ordered item, whether the dealing company placing an order is registered on a black list, or whether a condition of redemption registered to a computer by a prior contract of the dealing company is different from an actual condition of redemption. The error item information may also include whether there were arrears of payments in previous transactions, whether shipment quantity and price are different from the previously set-up minimum option, whether a quantity of the product in stock varies, or whether some items of the order sheet have been changed.

If an error for the above items occurs in the above process, the shipment of the corresponding product is temporarily suspended until the corresponding error is cleared (S124). Additionally, the suspension may last until the particulars of the corresponding error are reported. If the error is subsequently remedied, or if no error has occurred, then the shipment of the corresponding product proceeds (S125).

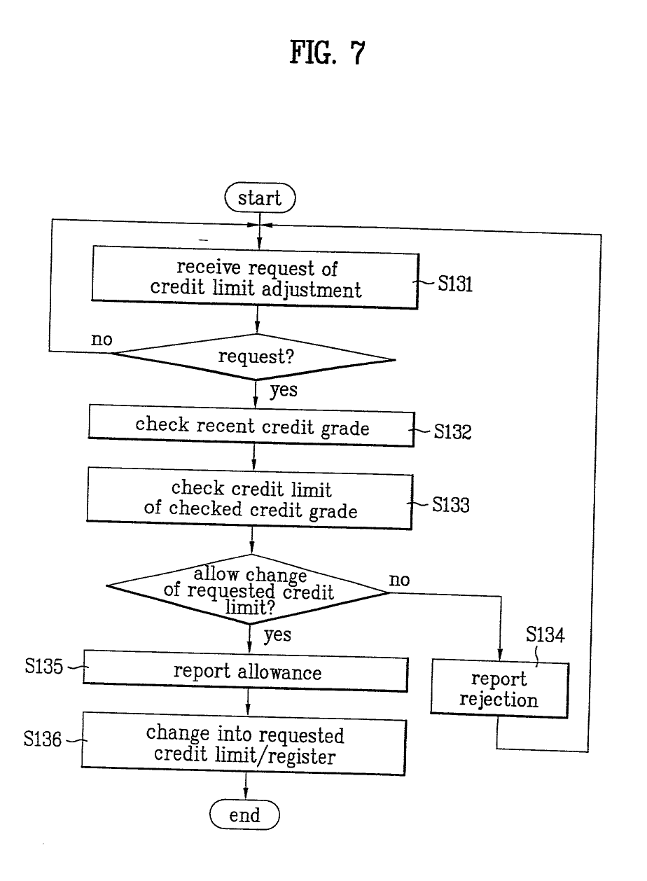

Meanwhile, referring to FIG. 7, if the order sheet is confirmed and the respective processes of the above described e-commerce system proceed, then the credit information management server 91 readjusts the credit limit amount given to the corresponding dealing company to be reduced down to a purchase order amount of the product.

In this case, when the corresponding dealing company substantially pays the purchase expense of the purchased product within the credit limit amount either before or on the due date, then the previously readjusted credit limit is again readjusted up to the initial credit limit.

It is preferable that the variation in the credit limit be adjusted in real-time, so that the dealing companies can accurately ascertain their current credit situation.

Accordingly, the credit limit of the dealing company is preferably displayed on a prescribed area of the corresponding web page when the dealing company requests on-line ordering.

Hence, when a specific dealing company selects a purchase of a specific product and the order is confirmed, the credit information management server 91 balances the credit limit given to the corresponding dealing company in accordance with the purchase expense of the corresponding product. The credit information management server 91 preferably stores such changed information in the database server 10, and displays the changed information on the corresponding web page in real-time.

It is preferable that the credit limit amount for any given dealing company be established with the sufficient consent of the dealing company. Thus, it is preferable that a dealing company be able to request a modification of its credit limit. While the requested modification will usually be fore additional credit, any modification is possible.

Thus, referring to FIG. 7, a request to adjust the credit limit is received through a web site carrying out an e-commerce (S131).

When the request is received, the web server 20 checks a recent credit grade of the corresponding dealing company (S132). The credit grade is preferably stored in the database server 10. A provided credit limit amount corresponding to the corresponding credit grade is also checked (S133).

If the requested credit limit increase is larger than the existing credit limit by a prescribed amount, the request is preferably rejected, and the rejection is reported (S134).

If, however, the requested credit limit increase is approximately similar to or less than the checked credit limit amount, or within a prescribed allowable range, the request is granted and the allowance, as well as the revised credit limit is reported so as to be registered in the database server 10 (S136).

Of course, it is possible to reduce the credit limit amount given to each of the dealing companies. Once such a decrement is demanded, the allowance for the demand is reported without additional processes. The credit limit is also readjusted to the demanded credit limit.

The above-explained processes correspond to the preferred embodiment of the present invention. However, not all of the described elements are necessary for any given e-commerce system. Instead, each of the above-explained respective processes could be used alone, or in any combination.

For instance, a first system and method for enabling e-commerce considering locations of the respective dealing companies and a distribution network (channel), a second system and method for enabling a smooth and fast handling of various transaction expenses for an e-commerce process, and a third system and method for enabling a convenient process for placing and receiving an order between the respective dealing companies each have their own characteristics respectively, and are independently applicable to other e-commerce systems.

Various embodiments of systems and methods having the abovementioned individual characteristics will be next described.

### Second Embodiment

An e-commerce system and method according to a second embodiment of the present invention enables e-commerce by considering locations of the respective dealing companies and a distribution network.

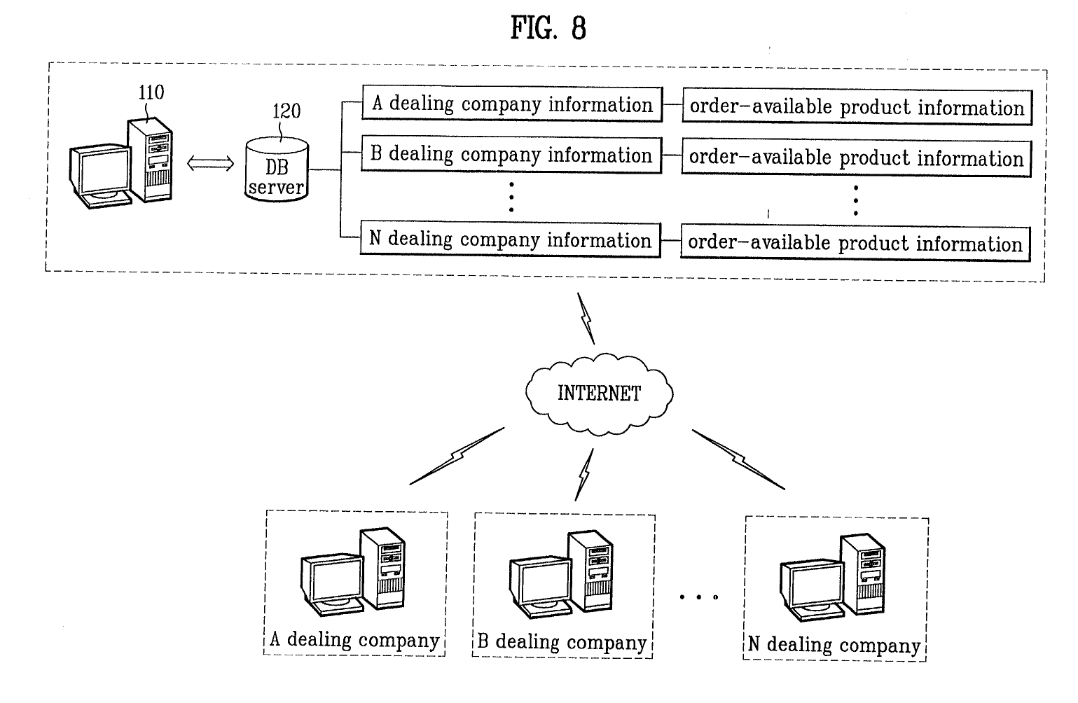

FIG. 8 illustrates an e-commerce system according to a second embodiment. Referring to FIG. 8, an e-commerce system preferably includes a database server 110 configured to store information about respective dealing companies, information about respective sales products, and other information. It further includes a web server 120, coupled to the database server 110, which is configured to select products available for order for the respective dealing companies, and to display product items of the selected items on an interface screen.

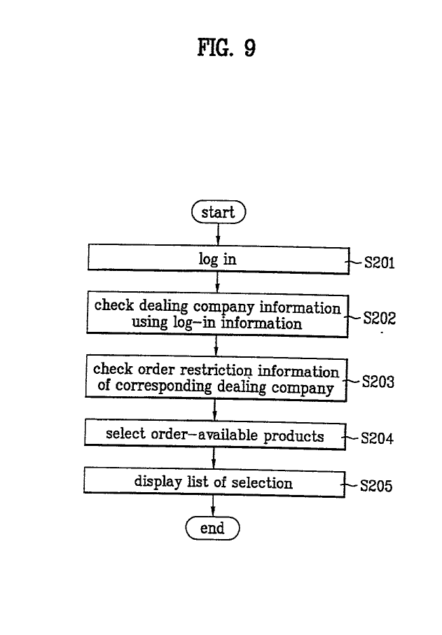

An operating method of the above-constructed e-commerce system according to the second embodiment of the present invention is described as follows with reference to FIG. 9.

First, a given dealing company logs-in to a web site for an e-commerce (S201). Upon the log-in, the web server 120 checks information of the corresponding dealing company using the log-in information (S202).

During such a process, the web server 120 determines what, if any, order restriction information is available for the corresponding dealing company (S203). This information is preferably retrieved from the database server 110.

The order restriction information is preferably information regarding a product for which sale is restricted by the corresponding dealing company among the products sold through the web site. The order restriction information is established by acquiring various information regarding, for example, location information of a corresponding dealing company and distribution channel information. This information is added to information asked of the respective dealing companies for services registration to the first corresponding web site. A registration process is then performed, indicating products to be as order-available or order-unavailable for the respective sales products and brand-new products on the basis of the acquired information.

Once the order restriction information for the corresponding dealing company is acquired through the above process, the web server 120 selects a list of the order-available products (S204). This list is selected based on the acquired order restriction information. The selection list is then displayed on the corresponding web page (S205). Access is thus given only to the respective displayed products in accordance with the purchase.

Therefore, complaints between the respective dealing companies regarding the purchase of products between the respective dealing companies located in the same or very similar area(s) are preferably prevented.

### Third Embodiment

An e-commerce system and method according to a third embodiment of the present invention enables smooth and fast handling of various transaction expenses for entire e-commerce processes.

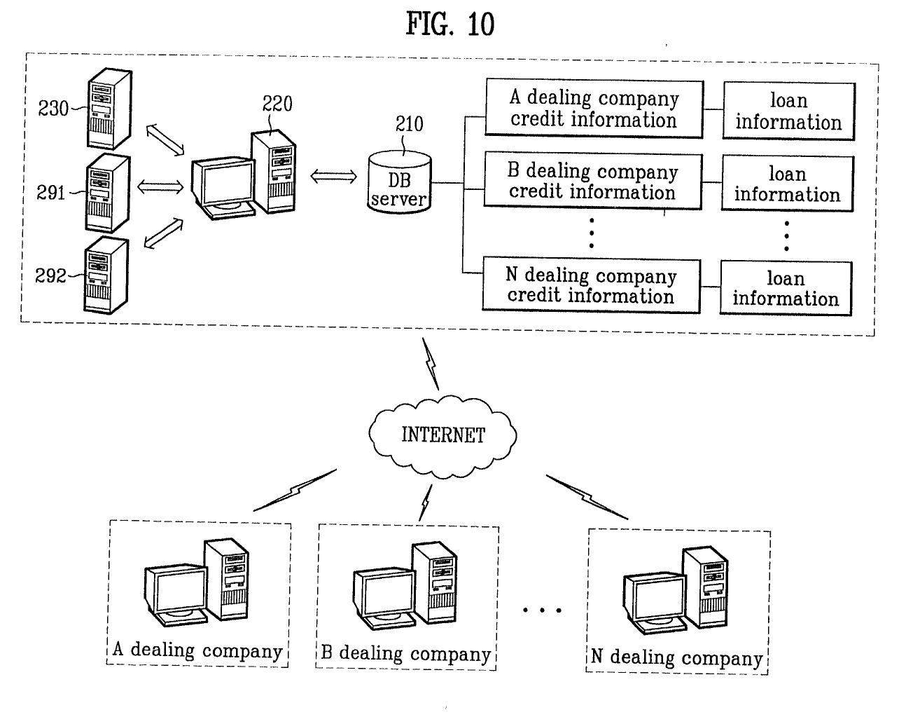

Referring to FIG. 10, an e-commerce system preferably includes a database server 210 configured to store information about respective dealing companies, credit information of the respective dealing companies, and credit limit amount information of the respective dealing companies. The credit limit amount information is established by considering the credit information. The database server further stores information of respective sales products. The system also includes an information acquisition server 230 for acquiring a series of information, such as credit information for the respective dealing companies and the like, and a web server 220 linked to the database server 210 configured to operate a web site to receive orders for on-line sales of the respective products within a credit limit of each of the dealing companies. Next, a credit information management server 291 is provided for managing credit information of the respective dealing companies, and a grade allotment server 292 is provided for establishing credit limit amounts of the respective dealing companies.

The credit information management server 291 yields a purchase expense of a specific dealing company upon receiving an order from the web site, and determines whether to approve the corresponding order by comparing the purchase expense to the company's credit limit.

The grade allotment server 292 allots grades as references to give the credit limit amounts of the respective dealing companies. The grades and credit limits are determined on the basis of information that is acquired from the information acquisition server 230 relating to the respective dealing companies.

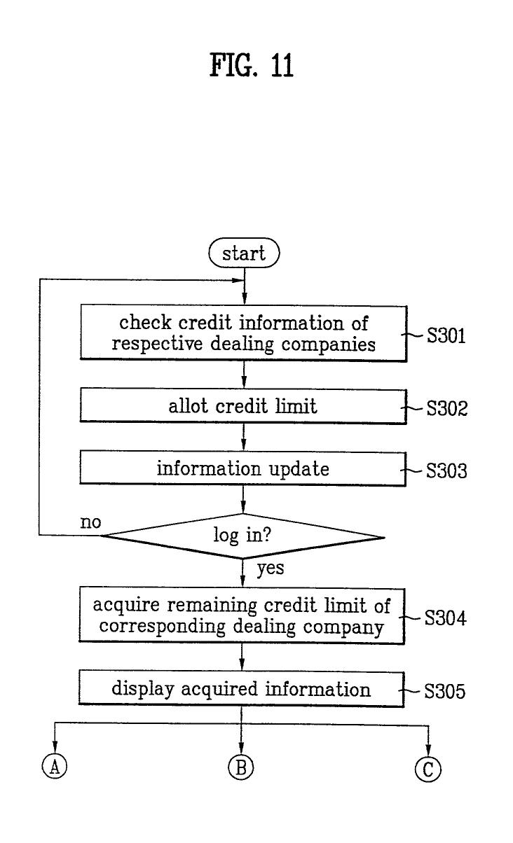

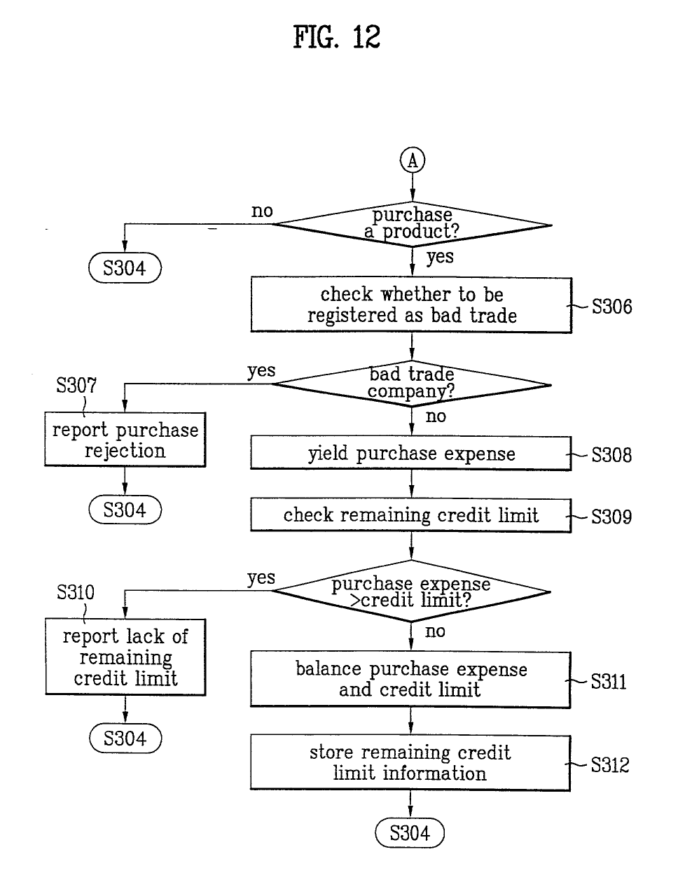

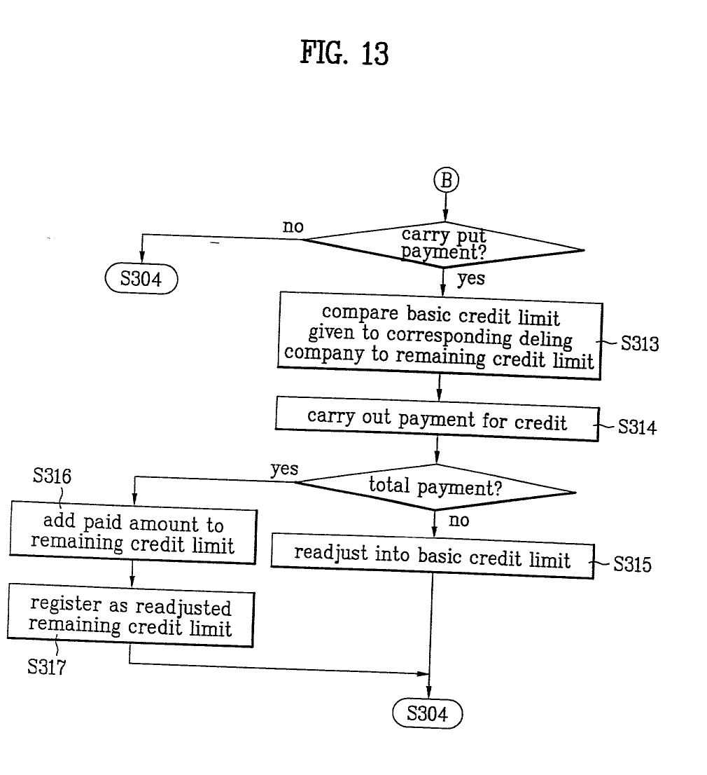

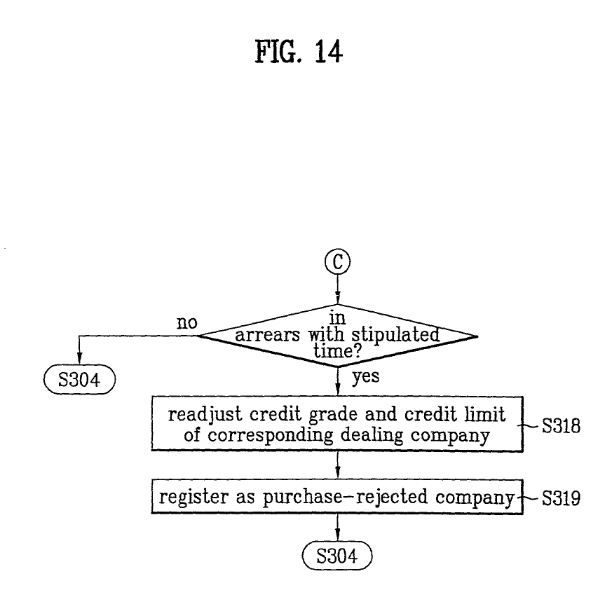

FIGS. 11-14 illustrate various aspects of an operating method of the above-constructed e-commerce system according to the third embodiment of the present invention.

Referring to FIG. 11, the grade allotment server 292 first acquires the credit information of the respective dealing companies and checks the credit grades of the respective dealing companies on the basis of the acquired credit information (S301). This is preferably done on a continual basis. Next, the grade allotment server 292 allots the credit limit amounts according to the credit grades (S302). The allotted credit limit amounts are then registered to the database server 210 (S303). The registration is preferably done on a continual basis.

When a specific dealing company logs in the e-commerce web site, the web server 220 acquires the information about the credit limit of that dealing company from the information registered in the database server 210 using the log-in information of the dealing company (S304).

The information about the above-acquired credit limit amount is preferably continuously displayed on the corresponding web page while the corresponding dealing company is connected to the web site (S305). This provides the dealing company with convenient use of the site, in that errors due to exceeding the remaining credit limit can be prevented.

When a specific product is purchased by a dealing company in accordance with the above condition, the web server 20 preferably determines whether the corresponding dealing company is registered on the black list of bad trading companies (S306). The black list includes trading companies that fail to make substantial payments on loans within a stipulated time. Purchases by such companies are thus restricted.

When the corresponding dealing company is registered as a bad trading company on the black list, it is reported that the product purchase is rejected (S307). If, however, the corresponding dealing company is not registered as a bad trading company, the purchase expense of the corresponding product is yielded (S308). It is also determined whether a purchase order expense for the selected product exceeds the remaining credit of the corresponding dealing company using the credit information management server 291 (S309).

If the purchase order expense for the selected product exceeds the remaining credit limit of the company, a shortage status of the remaining credit limit of the company is reported, and a readjustment of the purchase order is requested (S310). If, however, the purchase order expense for the selected product does not exceed the remaining credit limit, the purchase order expense is deducted from the corresponding credit limit (S311). Subsequently, the credit limit is readjusted as a remaining credit limit amount of the corresponding dealing company, and is registered to the database server 210 (S312). The adjusted credit limit is also displayed on the web page.

Next, when a dealing company makes a substantial payment for the purchased product within the credit limit amount on or before a stipulated time, the credit information management server 291 compares the company's basic credit limit with the remaining credit limit (S313), and thus calculates a payment-due amount.

Then, payment for the payment-due amount is preferably made (S314). In this case, when the corresponding dealing company settles accounts of the entire payment-due amount, the initially-given credit limit amount is restored by readjustment (S315). Additionally, information about the readjustment is registered to the database server. Alternatively, if the corresponding dealing company settles accounts of the payment-due amount in part, the settled amount is added to the remaining credit amount (S316). The remaining credit limit amount is thus adjusted, and information about this readjustment is registered to the database server (S317).

If a substantial settlement for the used credit limit amount is not made within the stipulated time, the credit grade and credit limit amount of the corresponding dealing company are readjusted to reflect this (S318). Additionally, a registration is preferably made such that no further purchases can be made, even if they are within the remaining credit limit amounts until the entire settlement is completed (S319).

Therefore, without settling the account for the product purchases through the web site, the respective companies may carry out the corresponding trades only with the previous credits so as realize fast performance of purchase.

### Fourth Embodiment

An e-commerce system and method according to a fourth embodiment of the present invention enables a convenient process for placing and receiving an order between the respective dealing companies in an e-commerce process.

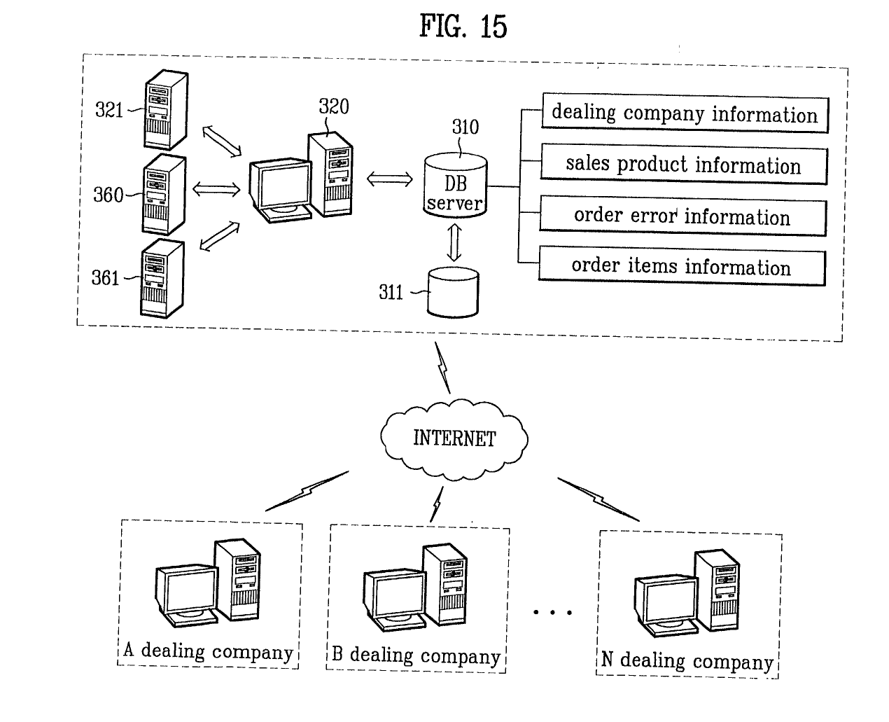

Referring to FIG. 15, an e-commerce system preferably includes a database server 310 for storing information about respective dealing companies, information about respective sales products, information about respective order errors, information of respective confirmed orders, and the like. The system further includes a web server 320 for operating a web site to receive orders for on-line sales of the respective products from the respective dealing companies. Next, an error processing server 321 is provided for searching an error through order information of the respective products received through the web site operated by the web server 320, and taking action in accordance with the search result. The system further includes an order confirmation server 360 for confirming orders that have no error or for which an error has been cured, and a divisional order processing server 361 for processing each scheduled order for which a complete shipment is not possible. Thus, the divisional order processing server 361 coordinates shipments of partial quantities for every set-up date for the entire order quantity of the ordered product, and registers the items of the scheduled order having been handled to a temporary order storage unit 311.

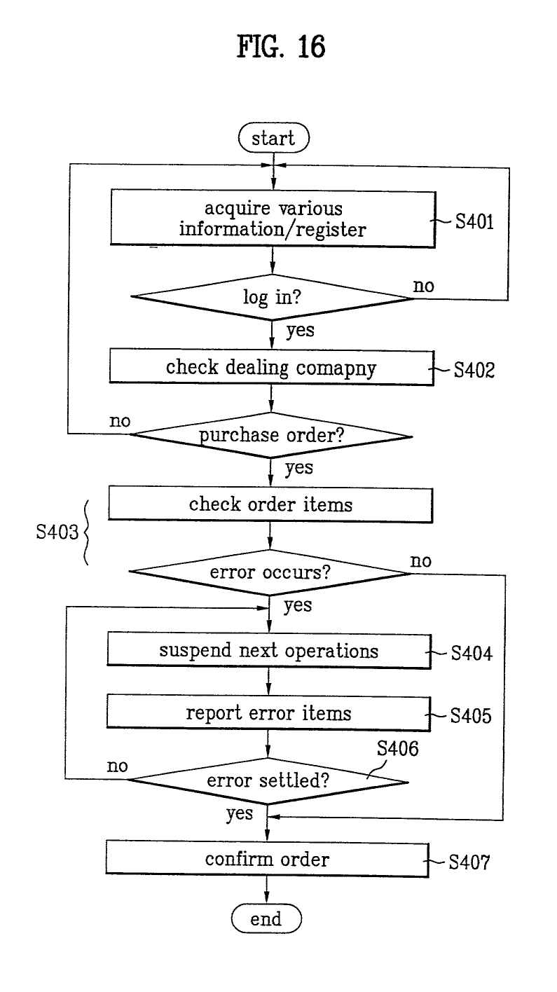

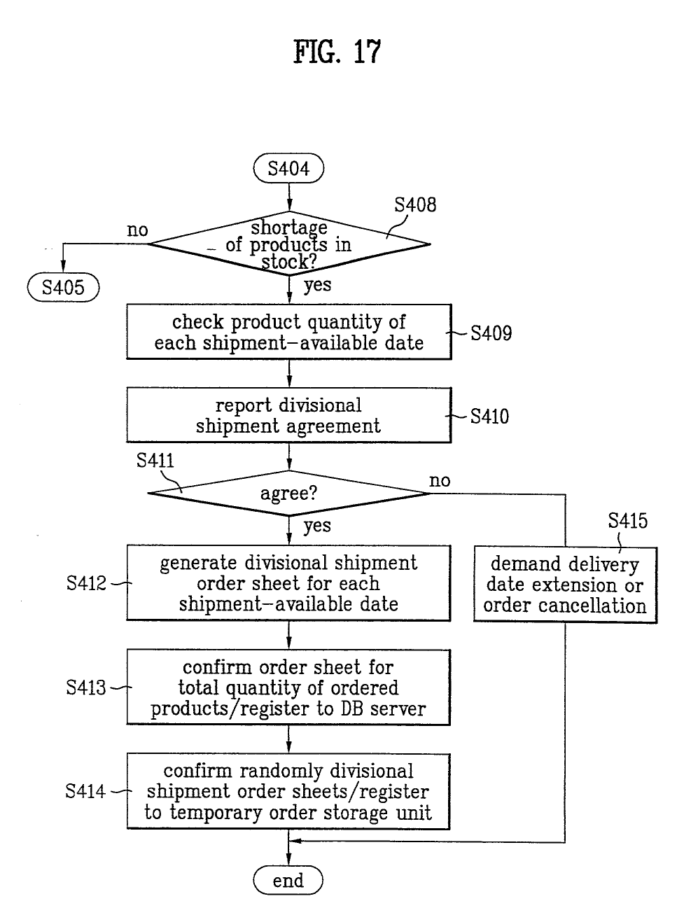

FIGS. 16 and 17 illustrate a method of operating the above-constructed e-commerce system according to the fourth embodiment of the present invention.

First, information about the respective dealing companies, the respective sales products, the respective order errors, and the like are continuously searched, and the corresponding search results are registered to the database server (S401). The web server 310 then carries out log-in connections of the dealing companies, and confirms the dealing companies (S402).

During this process, when an order for a product purchase is received from a specific dealing company, the error processing server 321 searches whether any of the ordered items of the dealing company belong to a previously established error list in the database server 310 (S403).

The error list may include items for which the ordered product fails to be listed on sales items, dealing companies that have been placed on a black list as a bad trading company, orders for which an ordered product quantity and a price are different from the previously set-up minimum order quantity and price, or items for which a quantity of an available product in stock for delivery is less than the quantity of the ordered product, and the like.

When the error processing server 321 detects and error, the next operations are temporarily suspended (S404). Such errors are items reported (S405), and it is then continuously checked whether the error has been cured (S406).

Referring to FIG. 17, if the error is generated due to a quantity of an available product in stock for delivery is less than the quantity of the ordered product, a divisional shipment is made, with the consent of the dealing company having placed the order (S411).

To perform the divisional shipment, the divisional order processing server 361 preferably determines a product quantity for each available shipment date (S409). It does this by acquiring information items ordered from a network built with the web server 320, the warehouse network 370 for managing a warehouse, and a company manufacturing the corresponding product. It further gathers information about the available products in stock and stored in the respective warehouses, and information about the quantity of the products for each shipment-available date. Using this information, a divisional shipment agreement may be reported (S410). If the agreement is accepted (S411), order sheets for the divisional shipments for the corresponding shipment-available dates are generated (S412).

When the error according to the order sheet from the dealing company is settled through a series of the above-explained processes, or when the error is settled automatically by the generation of the divisional shipment order sheets, the corresponding order sheet is confirmed (S407).

When the generation of the order sheet for the divisional shipment is completed, the order sheet for the total quantity of ordered products by the corresponding dealing company is confirmed as a single order sheet (S413). Additionally, the order sheets for the divisional shipments are confirmed randomly as divisional shipment order sheets (S414). The single order sheet is registered to the database server 310, and the randomly-confirmed divisional shipment order sheets are registered to the temporary order storage unit 311.

If the corresponding dealing company for the divisional shipment does not agree to the divisional shipment in step S411, a request for an extension of the due date of delivery for the corresponding trade order is made, or the order is cancelled (S415).

The web server 320 operating the e-commerce thus automatically checks whether errors have occurred in the orders placed by the respective dealing companies, and also automatically cures the generated errors in connection with other components. Errors are thereby prevented and cured.

The e-commerce system and method according to the embodiments broadly described herein have many advantages. For example, the present invention preferably controls the orders so that the same product model is not for sale through the respective distribution channels of the dealing companies. Therefore, smooth on-line B-to-B e-commerce is facilitated without affecting the off-line trade relations between the respective dealing companies.

Additionally, because orders can be controlled by each product model, when a special situation occurs (for example, stock-in-short, out-of-production, etc.), a real time sales restriction for the special situation is established, and the corresponding items are acknowledged by the corresponding dealing company. Therefore, unnecessary purchase orders are prevented.

Next, the dealing company that places an order for a product on-line accomplishes the corresponding trade only with a previous credit, and without immediately settling accounts. The speed of purchasing a product is thereby accelerated.

Moreover, the credit limit amount is determined in accordance with the credit grade and size of each dealing company, thereby making the e-commerce more dynamic.

Additionally, the companies placing and receiving orders, respectively, do not have to check and confirm individual order items of the corresponding product and the order for the product. Thus, the management of the items for the product order and the management of the confirmation are automatically carried out, thereby improving an efficiency of order management.

Furthermore, the issuance and management of the divisional shipment orders are automatically carried out when available-products in stock are in short, thereby managing the shipment more easily and conveniently.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An e-commerce system, comprising:
a database server configured to store information relating to at least one of a plurality of dealing companies, orders placed by each of the plurality of dealing companies, products for sale, order errors, and order-available products for the respective dealing companies;
a web server, coupled to the database server, and configured to operate a web-site to receive order sheets on-line from the plurality of dealing companies for an on-line sale of the products for sale and to select the order-available products for corresponding ones of the plurality of dealing companies to display only the available products on an interface screen;
an information acquisition server, coupled to the database server and configured to acquire information about each of the plurality of dealing companies, and to register the acquired information on the database server; and
an order control server configured to gather information about items ordered through the web server and the respective order error items stored in the database server, and to determine whether the error of the corresponding order is correct, and to execute a selective order control in accordance with the determination.

2. The system of claim 1, further comprising an order confirmation server configured to execute a confirmation of product orders received from each of the plurality of dealing companies.

3. The system of claim 2, further comprising a divisional order processing server, configured to perform a scheduled order processing so that a product shipment amounting to a partial quantity of a total order quantity of the order-confirmed product is performed at prescribed times, and to register the items of the scheduled order processing to a temporary order information storage unit.

4. The system of claim 3, wherein the temporary order storage unit comprises a prescribed information storing area allocated randomly to the database server.

5. The system of claim 1, further comprising a shipment confirmation server coupled to a warehouse network, and configured to manage each of a plurality warehouse storing products in stock so as to confirm a shipment of the corresponding order quantity of each of the orders, wherein the shipment confirmation server is configured to be controlled in connection with the web server and database server respectively.

6. An e-commerce system, comprising:
a database server configured to store at least one of information relating to a plurality of dealing companies, information about products offered for sale, and information about order-available products for each of the plurality of dealing companies; and
a web server, coupled to the database server, and configured to operate a web-site for an on-line sale of the products offered for sale, and to select the order-available products for each of the dealing companies so as to display only available items on an interface screen.

7. An e-commerce system, comprising:
a database server configured to store information about a plurality of dealing companies, credit information for each of the plurality of dealing companies, credit limit information for each of the plurality of dealing companies that is established by considering the credit information, information of sales products, and information of an order control for each situation; and
a web server coupled to the database server, and configured to operate a web-site to receive an on-line order for an on-line sale of each of the products within a credit limit of each of the plurality of dealing companies.

8. The system of claim 7, further comprising a credit information management server configured to determine a purchase expense of a specific dealing company submitting an order through the web site, determining whether to approve the corresponding order by comparing the purchase expense to the credit limit given to the corresponding dealing company, and managing variations of the credit limits of the respective dealing companies.

9. The e-commerce of claim 8, further comprising a grade allotment server configured to acquire information relating to the respective dealing companies and allot grades as references to give the credit limit of the respective dealing companies on the basis of the acquired information.

10. An e-commerce system, comprising:
a database server configured to store information about a plurality of dealing companies, credit information for each of the plurality of dealing companies, and order restriction information of a plurality of products; and
a web server, coupled to the database server, and configured to operate a web site to receive on-line orders for an on-line sale of each of the plurality of products, acquire information about the respective products and dealing companies and registering the acquired information to the database server, and perform order control for order-generating dealing companies, when an order for a product purchase is generated from the corresponding dealing companies.

11. The e-commerce system of claim 10, further comprising an order control set-up server coupled to the database server and web server, and configured to restrict prescribed orders for each of the dealing companies in accordance with the information about the products registered in the database server and information about the respective dealing companies.

12. The system of claim 10, wherein the order restriction information includes at least one of amounts in stock by the respective models of sales products, sale or sale-suspension of the respective models of the sales products, out-of-production or production of the respective models of the sales products.

13. An e-commerce system, comprising:
a database server configured to store information relating to a plurality of dealing companies, information about respective sales products, information about respective order errors, and item information of respective confirmed orders;
a web server configured to operate a web-site to receive orders for on-line sales of the respective sales products from the plurality of dealing companies;
an error processing server configured to identify errors in order information of the respective sales products received through the web site operated by the web server; and
an order confirmation server configured to confirm orders having no error and orders for which an error has been cured.

14. The system of claim 13, further comprising a divisional order processing server configured to process each scheduled order to perform a partial product shipment at prescribed times, the partial product shipment amounting to shipment of a partial quantity of an entire order quantity of the confirmed order, and to register to a temporary order storage unit the items of the scheduled order having been processed, wherein the divisional order processing server is coupled to the web server, the database server, and a warehouse network configured to manage a warehouse.

15. The system of claim 14, wherein the temporary order information storage unit is an information storage area randomly allocated in the database server.

16. The system of claim 13, further comprising a shipment confirmation server coupled to each of at least one warehouse network and configured to confirm whether a corresponding order quantity of the confirmed orders has been shipped, wherein the shipment confirmation server is controlled in connection with the web server and database server respectively, and wherein each of the warehouse networks is configured to manage a corresponding off-line warehouse storing products in stock.

17. A method of operating an e-commerce system, comprising:
checking order restriction information for a dealing company from a database server when an on-line connection is made from the respective dealing company;
classifying products into order-available products and order-unavailable products on the basis of the order restriction information;
displaying a list of the order-available products and information about the corresponding products on a web page;
yielding an expense of an ordered product when an order for a product in the displayed order-available products is received;
determining whether the yielded expense exceeds a credit limit of the dealing company, and determining whether the received purchase order items are restricted from purchase for the dealing company, and whether the received purchase order items are order error items; and
confirming an order on the corresponding purchase order items if the credit limit is not exceed, the order items are not restricted, and the order items are not order error items.

18. The method of claim 17, further comprising:
reporting that the yielded expense exceeds the credit limit if the yielded expense exceeds the credit limit assigned to the dealing company and requesting a readjustment of the order; and
deducting the expense from the credit limit and readjusting the credit limit into a remaining credit amount of the dealing company if the yielded expense does not exceed the credit limit assigned to the dealing company.

19. The method of claim 17, wherein the credit limit of the dealing company is established by checking a credit grade of the dealing company when a membership registration is received from the dealing company, generating an order-available credit limit based on the credit grade and a size of the dealing company, and storing information about the order-available credit limit and other information of the dealing company in the database server.

20. The method of claim 19, wherein the credit grade of the dealing company is established using at least one of grade information attained by having the dealing company evaluated by a banking or credit corporation, general credit information about the dealing company evaluated by different companies, and historic information based on previous transactions with the dealing company.

21. The method of claim 17, further comprising:
checking at least one of previous transaction items, credit degree in accordance with a trade, and overall creditworthiness of the dealing company;
establishing different credit grades for each of a plurality of dealing companies through the above checking; and
increasing or decreasing the credit limit of each of the dealing companies in accordance with the established credit grades.

22. The method of claim 17, further comprising:
receiving a request to increase the credit limit from the dealing company;
rechecking an entire credit grade of the dealing company when the request is received;
confirming the credit limit provided in accordance with the checked credit grade; and
one of reporting a rejection against the request if the requested credit limit increase from the dealing company is larger than the checked credit limit amount by a prescribed amount and reporting an allowance for the request and readjusting the credit limit of the corresponding dealing company if the requested credit limit increase is within an allowable range.

23. The method of claim 22, wherein the requested credit limit increase is within the allowable range if it is less than or equal to the existing credit limit.

24. The method of claim 17, further comprising re-adjusting a remaining credit limit to the initially allotted credit limit for the dealing company if a substantial payment is made for products purchased within the credit limit within prescribed time period.

25. The method of claim 17, further comprising displaying the credit limit of the dealing company on a corresponding web page when a trade order is requested on-line by the dealing company and, if the dealing company selects a purchase of a specific product, reducing the displayed credit limit in accordance with a purchase expense of the specified product in-real time.

26. The method of claim 17, wherein purchase order items are determined to be restricted if the received purchase order items are indicated to be restricted in the database server, and wherein an order is confirmed only if the item is not restricted.

27. The method of claim 26, wherein items can be restricted on a general basis to all dealing companies, or can be restricted only for prescribed dealing companies.

28. The method of claim 27, wherein a general basis restriction occurs when at least one of a quantity of stock of the corresponding item is insufficient, sales of the corresponding item have ceased, the corresponding item is no longer manufactured, and a quantity of the purchase order is less than a minimum order-available quantity of the corresponding item.

29. The method of claim 27, wherein order restriction for prescribed dealing companies occurs when at least one of the prescribed dealing company goes out of business, the prescribed dealing company becomes insolvent, the prescribed dealing company engages in illegal activity, the prescribed dealing company is in arrears, and the prescribed dealing company has an excess quantity of ordered items compared to a credit of the corresponding dealing company.

30. The method of claim 26, wherein when a prescribed product is to be shipped on a confirmed order, further comprising:
searching information of the corresponding product from the database server; and
temporarily suspending the shipment of the corresponding product if an error corresponding to prescribed error conditions for the corresponding product is determined.

31. The method of claim 30, wherein the prescribed error conditions comprise at least one of an item of the corresponding product is different from the ordered item, the dealing company placing the order is registered on a blacklist, a condition of redemption registered to a computer by a prior contract of the dealing company is different from an actual condition of redemption, an arrearage of payments in previous transactions exists, a shipment quantity and price are different from a prescribed minimum option, a quantity of the product in stock varies, and items on the order sheet have been changed.

32. The method of claim 17, further comprising:
temporarily suspending a subsequent operation if the received purchase order items are order error items, and reporting the order error items to indicate an error condition;
checking to determine whether the error condition has been corrected;
confirming an order sheet for non-error order items or error-corrected order items.

33. The method of claim 32, wherein confirming the order sheet further comprises:
determining whether a shipment of an ordered product quantity is possible on a requested date;
if the shipments is not possible on the requested date, determining a possible shipment date for each quantity of the corresponding product; and
confirming the order sheet for the corresponding order by generating an order sheet for a divisional shipment for each of the confirmed possible shipment dates.

34. The method of claim 33, wherein the generation and confirmation of the order sheets for the shipment on each of the possible shipment dates is performed by confirming the order sheet for an entire quantity of the products initially ordered, and generating order sheets for the respective product quantities to be shipped by the respective possible shipment dates.

35. The method of claim 34, further comprising:
generating divisional worksheets in accordance with respective scheduled shipment quantities;
confirming the respective generated divisional order sheets;
storing the confirmed divisional worksheets in a temporary order storage unit; and
when a product is shipped for a given one of the stored divisional order sheets, deleting information of the corresponding divisional order sheet from the temporary order storage unit.

36. The method of claim 33, further comprising transmitting an opinion about the divisional shipments to a corresponding dealing company to request an agreement with the corresponding dealing company having placed the order for which full shipment is not possible, wherein the opinion and request are transmitted when the order sheets for the divisional shipments on the respective possible shipment dates are generated, and wherein the agreement is to allow the shipment on a date other than the requested date.

37. The method of claim 36, wherein if the agreement on the divisional shipments is not accepted by the dealing company, further comprising:
re-checking the possible shipment dates; and
one of confirming the order of the corresponding product if it is determined that the shipment is possible on the requested delivery date, delaying the delivery date by having a conference with the dealing company, and canceling the order if the shipment is not possible on the requested delivery date.

38. The method of claim 32, wherein the order error items include at least one of products which fail to exist on a sales list, products ordered by a dealing company that is not authorized, products for which a price and quantity differ from a prescribed minimum price and quantity, and products for which a quantity of the available product in stock is less than the amount ordered.

39. The method of claim 38, wherein the order error items are reported to the dealing company having placed the corresponding order sheet and the web site that receives the respective order sheets.

40. The method of claim 32, wherein when the corresponding products for the confirmed order are to be shipped, further comprising:
searching prescribed information items for the products to be shipped from the database server; and
when a prescribed error condition exists in the information items corresponding to the product to be shipped, temporarily suspending the shipment of the corresponding product until the error is resolved.

41. The method of claim 40, wherein the prescribed error condition includes at least one of an item on the corresponding product is different from the ordered item, the dealing company having placed the order is registered on a blacklist, a redemption registered to a computer by a prior contract of the dealing company is different from an actual condition of redemption, an arrearage of payments in previous transactions is outstanding for the dealing company, a shipment quantity and price are different from a previously prescribed minimum option, a quantity of the product in stock varies, and items of the order sheet are changed.

42. A method of operating an e-commerce system, comprising:
checking order restriction information for a dealing company from a database server when an on-line connection is made from the dealing company;
classifying sales products into order-available and order-unavailable products based on order restriction information; and
displaying a list of the order-available products and information about the corresponding products on a web page.

43. The method of claim 42, wherein the order-available products are ordered online from the displayed web page.

44. A method of operating an e-commerce system, comprising:
receiving an online order for a product from a dealing company;
yielding a sales expense of the ordered product in accordance with product pricing information;
determining whether the yielded expense exceeds a credit limit allocated to the dealing company;
if the yielded expense exceeds the credit limit allocated to the dealing company, reporting that the yielded expense exceeds the credit limit amount so as to request a readjustment of the order from the dealing company; and
if the yielded expense does not exceed the allocated credit limit, deducting the expense from the credit limit allocated to the dealing company so as to reduce the credit limit for the dealing company.

45. The method of claim 44, wherein the credit limit for the dealing company is established by a determining a credit grade of the dealing company when a membership registration is received from the dealing company, calculating an order-available credit limit amount for the dealing company in accordance with the credit grade and a size of the dealing company, and storing information about the order-available credit limit for the dealing company database server.

46. The method of claim 45, wherein the credit grade is established using at least one grade information obtained by having the dealing company evaluated by a banking or credit corporation, general credit information regarding the dealing company, and historic information corresponding to a previous transaction record for the dealing company.

47. The method of claim 44, further comprising:
periodically checking at least one of previous transaction items of the dealing company, a credit degree in accordance with a trade, and other information relating to a creditworthiness of the dealing company;
allocating a credit grade based on the results of the periodic checking; and
increasing or decreasing the credit limit for the dealing company in accordance with the allocated credit grade.

48. The method of claim 44, further comprising:
receiving a request to increase the credit limit from the dealing company;
re-checking an entire credit grade of the dealing company when the request is received;
checking a basic credit limit provided in accordance with the credit grade;
rejecting the request if the requested credit increase exceeds the checked credit limit by a prescribed amount; and
approving the request and re-adjusting the credit limit of the dealing company to the requested amount if the requested credit limit is within a prescribed range.

49. The method of claim 48, wherein the request is allowed if the requested credit limit is approximately the same as the checked credit limit.

50. The method of claim 44, further comprising re-adjusting information of a remaining credit limit to the initially established credit limit if a substantial payment is made for products purchased within the credit limit within a prescribed period of time after a purchase.

51. The method of claim 44, further comprising displaying the credit limit of the dealing company on the corresponding web page when a trade order is requested on-line by the dealing company, and if the dealing company selects a purchase of a specific product, balancing the display credit limit amount and a purchase expense of the specific product in real-time.

52. A method of operating an e-commerce system, comprising:
receiving on-line orders for product purchases from at least one dealing company through a prescribed web-site;
comparing products for which orders are received online to prescribed order restriction items to determine if an ordered product is a restricted product;
one of restricting the corresponding order if the ordered product is restricted and confirming the order if the ordered product is not restricted.

53. The method of claim 52, wherein the prescribed order restriction items include product restricted items that are restricted to all dealing companies and dealing company restricted items that are restricted from order only to prescribed dealing companies.

54. The method of claim 53, wherein the product restricted items include products for which a corresponding stock quantity is low, products for which sales have ceased, products which are no longer manufactured, and products for which a quantity of the purchase order is less than a minimum order-available quantity.

55. The method of claim 53, wherein the dealing company restricted items include items ordered by a dealing company where at least one of the dealing company goes out of business, becomes insolvent, engages in illegal activities, is in arrears with respect to an earlier purchase order, and is maintaining an excessive order quantity compared to an available credit of the dealing company.

56. The method of claim 52, wherein when a shipment of the corresponding product is to be performed for the confirmed order, further comprising:
searching information on various items for the shipment product from a database server; and
when an error corresponding to prescribed error conditions is found to exist based on the search, temporarily suspending the shipment of the corresponding product until the error is resolved.

57. The method of claim 56, wherein the prescribed error conditions comprise at least one of a difference is detected between an item of the corresponding product and the ordered item, the dealing company placing the order is registered on a blacklist, a condition of redemption registered to a computer by a prior contract of the dealing company is different from an actual condition of redemption, an arrearage of payments in a previous transaction exists, a shipment quantity and price are different from a prescribed minimum option, a quantity of the product in stock varies, and a change has been made to at least one item of the order sheet.

58. A method of operating an e-commerce system, comprising:
receiving on-line orders for product purchases from at least one dealing company through a prescribed web-site;
determining whether each item ordered belongs to a group of prescribed error items;
temporarily suspending subsequent operations for items determined to belong to the group of prescribed error items;
reporting the ordering of items that are determined to belong to the group of prescribed error items and continuously checking to determine if the error has been resolved; and
confirming an order sheet for each of items ordered that are not in the group of prescribed error items and items for which the error has been corrected.

59. The method of claim 58, wherein confirming the order sheet comprises:
determining whether a shipment is possible on a requested date for an ordered quantity of a product;
if it is determined that the shipment is not possible, determining a shipment-available date for each quantity of the corresponding product; and
confirming the order sheet for the corresponding order by generating an order sheet for a divisional shipment for each of the confirmed shipment-available dates.

60. The method of claim 59, wherein the generation and confirmation of the order sheet for the shipment on each of the shipment-available dates is performed by confirming the order sheet for an entire quantity of the initially ordered products, and generating order sheets for the respective product quantities to be shipped by the respective shipment-available dates.

61. The method of claim 60, further comprising:
generating divisional order sheets in accordance with respective scheduled shipment quantities;
confirming the respective generated divisional order sheets;
storing the confirmed respective divisional order sheets in a temporary order storage unit; and
deleting information of the corresponding divisional order sheets from the temporary order storage unit when the corresponding product is shipped.

62. The method of claim 59, further comprising seeking an agreement regarding the divisional shipment and the respective shipment-available dates with the dealing company having placed the order by transmitting an opinion about the divisional shipments to the dealing company when the order sheets for the divisional shipments are generated.

63. The method of claim 62, wherein if the agreement regarding the divisional shipment is not accepted by the dealing company, further comprising:
re-checking the shipment-available dates for the corresponding products; and
one of confirming the order of the corresponding product if it is determined that the shipment is possible within the requested delivery date, delaying the delivery date by having a conference with a corresponding dealing company, and canceling the order if it is determined that the shipment is impossible by the requested delivery date.

64. The method of claim 58, wherein the prescribed order error items include at least one of items for which the ordered product fails to exist on a sales list, the dealing company that placed the order is not authorized, a price and quantity of the ordered product differ from a previously established minimum price and quantity, and a quantity of the available products in stock is less than an amount ordered.

65. The method of claim 64, wherein the order error items are reported by the dealing company having placed the corresponding order sheet and the web site that receives the respective order sheets.

66. The method of claim 58, wherein when the shipment of the corresponding product for the confirmed order is to be carried out, further comprising:
searching prescribed information items from a database server for the corresponding product to be shipped; and
when an error corresponding to prescribed order error items exists in the information items of the corresponding product to be shipped, temporarily suspending the shipment of the corresponding product until the error is corrected.

67. The method of claim 66, wherein the prescribed error items for the shipment product include at least one of an item of the corresponding product is different from the ordered item, the dealing company placing the order is registered on a blacklist, a condition of redemption registered by a prior contract of the dealing company is different from an actual condition of redemption, the dealing company is in arrears on payments in previous transaction, a shipment quantity and price are different from a prescribed minimum option, a quantity of the product in stock varies, and at least one item on the order sheet has been changed.
